(19) United States
(12) Patent Application Publication
(10) Pub. No.: US 2010/0151769 A1
(43) Pub. Date: Jun. 17, 2010

(54) Turkey Call

(76) Inventor: Richard Coffield, Bluffton, SC (US)

Correspondence Address: Clements Bernard PLLC, 1901 Roxborough Road, Suite 250, Charlotte, NC, 28211, US

(21) Appl. No.: 12/715,085

(22) Filed: Mar. 1, 2010

Related U.S. Application Data
(63) Continuation-in-part of application No. 11/788,878, filed on Apr. 23, 2007.

(51) Int. Cl. A01M 31/00

(52) U.S. Cl. 446/418

(57) ABSTRACT

The present invention provides methods and systems for a turkey call producing the sound of a turkey including a bottom side, a top side, a slate side and a two ends collectively forming a cavity therein. A flexible sounding board has a first end and a second end positioned within the cavity, wherein the sounding board is capable of vibrating and producing the sound of a turkey. The slate side having a slate disposed thereon, and a striker, the striker having a strike peg and a block member, the strike peg extending from a surface of the block member.

The present non-provisional patent application is a continuation-in-part of co-pending U.S. patent application Ser. No. 11/788,878, filed on Apr. 23, 2007, and entitled “TURKEY CALL.”

### FIELD OF THE INVENTION

The present invention is directed to a turkey call for mimicking turkey vocalizations, and in particular, a turkey call providing a greater variety of sounds from a single unit.

### BACKGROUND OF THE INVENTION

It is well known in the art to utilize artificial devices to mimic and attract turkeys at a turkey hunt. The more realistic the sound the more likely the turkey is to be attracted or answer the sound. In order to optimize the number of turkeys responding to a call, a single call must be capable of producing a full range of “turkey voices” from high-pitched cackles to the raspy calls of more mature turkeys.

Turkey calls come in two basic types, a frictional call and a wind call. This invention is directed to improvements in frictional calls. Frictional calls also come in two generic embodiments. There are strike calls and box calls. The strike call, also known as a slate call, utilizes a peg-type striker in one hand and a fixed area square pot having a depth of about one to two inches and a diameter of about three inches. A striking surface, such as slate, glass or metal is affixed to the top of the pot so that it forms a hollow chamber. A striker is usually formed of wood and has a chamfered or a rounded striking end, which is utilized to strike the slate. The size of the pot and the slate are adjusted to affect the volume and pitch of the call.

The second type of call, the box call, has an open-top box and a paddle. The paddle is scraped along the edges of the box-top opening. Usually the paddle and the sides of the box are curved.

These calls have been satisfactory. However, they suffer from the disadvantage that in order to make a variety of turkey sounds, a variety of calls, both box and slate are needed. Accordingly, it is desired to provide a call that overcomes the shortcomings of the prior art.

### BRIEF SUMMARY OF THE INVENTION

A call includes a body having a front panel and a back panel in an opposed relationship to the front panel. A top panel and a bottom panel are disposed between the front panel and back panel in opposed relationship to provide a space between the front panel and back panel. A first side and a second side are disposed between the front panel and the back panel. The first side has a striking panel made of a material which resonates at a frequency that mimics the sound of a turkey. The second side has a sounding board capable of flexure so as to vibrate.

The sounding board is offset relative to the edges of the remaining sides to form a recess. The call also includes a striker hanger or striker body, a peg extends from the striker body.

In a preferred embodiment, a storage compartment is formed in the striker body. During use, the striker is scraped along the material side to resonate the material to mimic a turkey. The body is scraped along the wood side to resonate the wood.

### BRIEF DESCRIPTION OF THE DRAWINGS

For a fuller understanding of the invention, reference is had to the following description taken in connection with the accompanying drawings in which:

FIG. 1 is a top plan view of a turkey call constructed in accordance with the invention;

FIG. 2 is a side elevation view of a striker constructed in accordance with the invention;

FIG. 3 is a wood side elevation view of a call body constructed in accordance with the invention;

FIG. 4 is a perspective view showing the opposed side of the turkey call box relative to FIG. 3;

FIG. 5 is a perspective view of the striker in accordance with the invention;

FIG. 6 is a sectional view taken along line 6-6 of FIG. 1;

FIG. 7 is a sectional view taken along line 7-7 of FIG. 2;

FIG. 8 is a perspective view of an exemplary embodiment of the turkey call of the present invention;

FIG. 9 is a perspective view of an exemplary embodiment of the turkey call of the present invention;

FIG. 10. is an exploded view of an exemplary embodiment of the striker;

FIG. 11 is a sectional view taken along line 4 of FIG. 8; and

FIG. 12 is a sectional view taken along line 5 of FIG. 8.

### DETAILED DESCRIPTION OF THE INVENTION

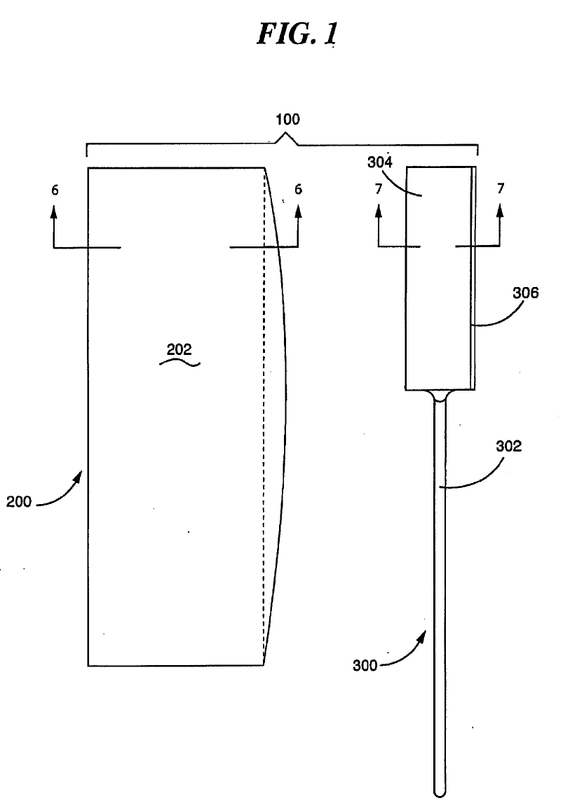

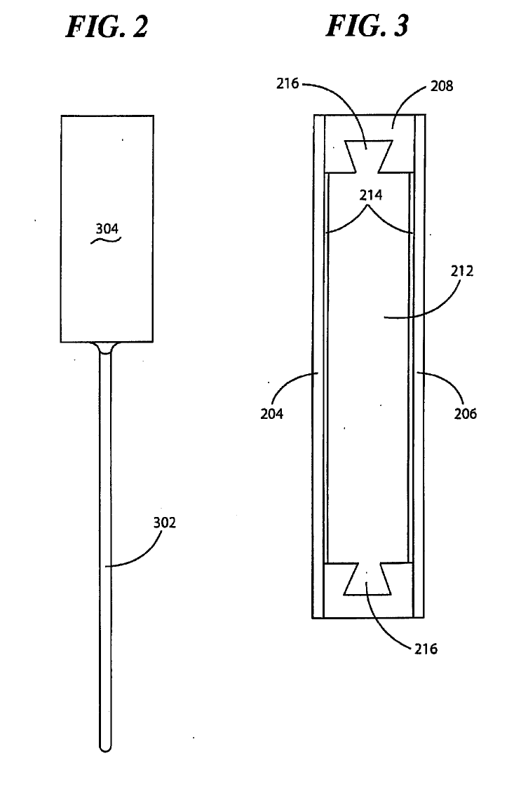

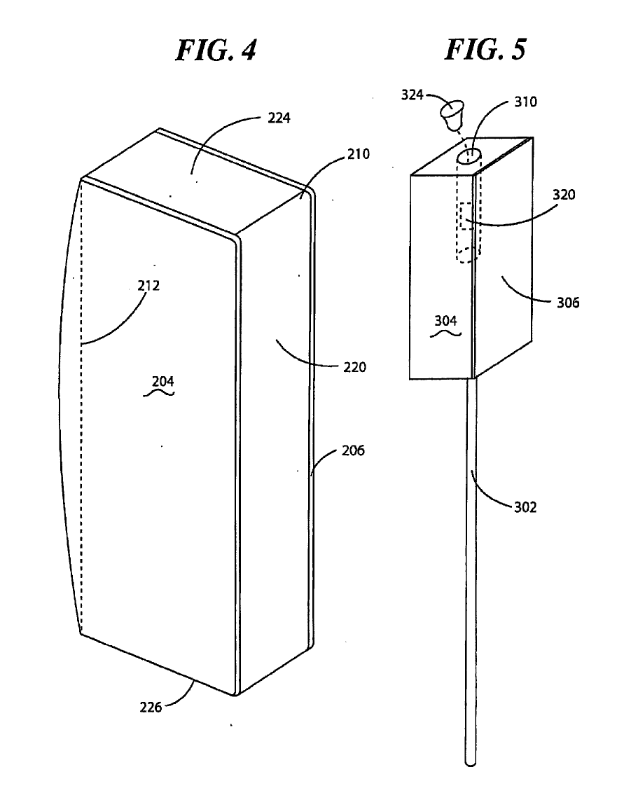

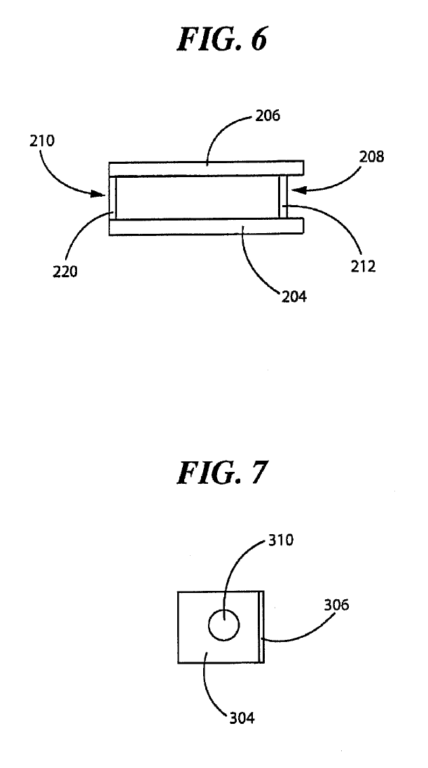

Reference is made to FIG. 1 in which a call, generally indicated as 100, includes two primary components, a box 200 and striker 300. The box 200 includes a substantially rectangular hollow housing 202. Housing 202 includes a bottom side 204, a topside 206, a wood side 208 and slate side 210 opposed to wood side 208. Wood side 208 is slightly recessed (phantom FIG. 4).

A flexible sounding board 212 capable of resonating is disposed between sides 204, 206 and is recessed at wood side 208 relative to sides 204, 206. Sounding board 212 is preferably formed of mahogany or cedar in a non limiting embodiment. However, similarly resonating woods or plastics may be used. Furthermore, in one embodiment, sounding board 212 is spaced from sides 204, 206 by respective spaces 214 to allow freer vibration. It is also held in place by a tongue and groove or flat locking mechanism 216 disposed at opposed ends of sounding board 212. In this way, wood 212 is suspended within housing 202 and may freely resonate. However, all that is necessary is that sounding board 212 be affixed at either end within box 200 so as to vibrate at a resonance matching a turkey's call when a paddle is slid above it to contact and vibrate edges of bottom side 204 and topside 206. In a preferred embodiment, the sides 204, 206 are curved as they ascend above sounding board 212.

In contrast thereto, a slate 220 is disposed at slate side 210 of housing 202 flush with sides 204, 206. In a preferred embodiment, slate 220 is coextensive with and butts against sides 204, 206. Housing 202 is closed at ends 224, 226.

Striker 300 includes a striking peg 302 and in a preferred embodiment, striker peg 302 extends from a striking block 304. Striker peg 302 is preferably rounded or chamfered. Striker peg 302 and striking block 304 is preferably formed of wood, in particular. A slate 306 is affixed to at least one side of striker block 304. As shown in FIGS. 5 and 7, a closed end channel 310 is disposed within striker block 304 and is adapted to receive and store chalk 320 therein. Closed end channel 310 is selectively sealed with an abrasive 324 such as sandpaper, steel wool or an abrasive sold by 3M.

Call 100 is capable of providing two unique calls, the traditional slate strike call as well as a modified box call. In a first use, to create the slate turkey call, slate 220 may be roughed up with abrasive 324, which is removed from closed end channel 310. Abrasive 322 is then replaced into closed end channel 310 and the end is closed with abrasive 324, acting as a stopper. Then, as is known in the art, the user holds housing 204 in one hand with the slate side 206 face up. With the other hand, the user grabs striker 300 and strikes slate 220 with striker peg 302. When sounds are created, it is because slate 220 resonates. Because housing 202 is hollow, the resonating slate 220 also causes sounding board 212 to resonate enhancing the overall sound.

To create a different type of call, the user reverses the housing 204 by flipping it over in their hand so that wood side 208 faces up. The user then grabs striker 300, either by peg 302 or block 304 and slides slate 306 across the edges of sides 204, 206 to resonate sounding board 212. Again, because housing 202 is hollow, the resonating sounding board 212 operates in conjunction with slate 220 to provide a better turkey call sound. Chalk 320 is used to prepare the surface of peg slate 306.

It should be noted that in the above descriptions, wood side 208 was described as including a resonating tongue or reed of wood. However, any material capable of resonating within housing 202 in response to the use of slate 306 across the sides of housing 202 to mimic a turkey call may be utilized. Similarly, any other material such as glass or aluminum that resonates at a frequency that mimics a turkey call when struck by peg 302 may be utilized for slate side 210.

Furthermore, by providing two resonant surfaces at opposed surfaces of a hollow housing, there is a synergy resulting in a better turkey call.

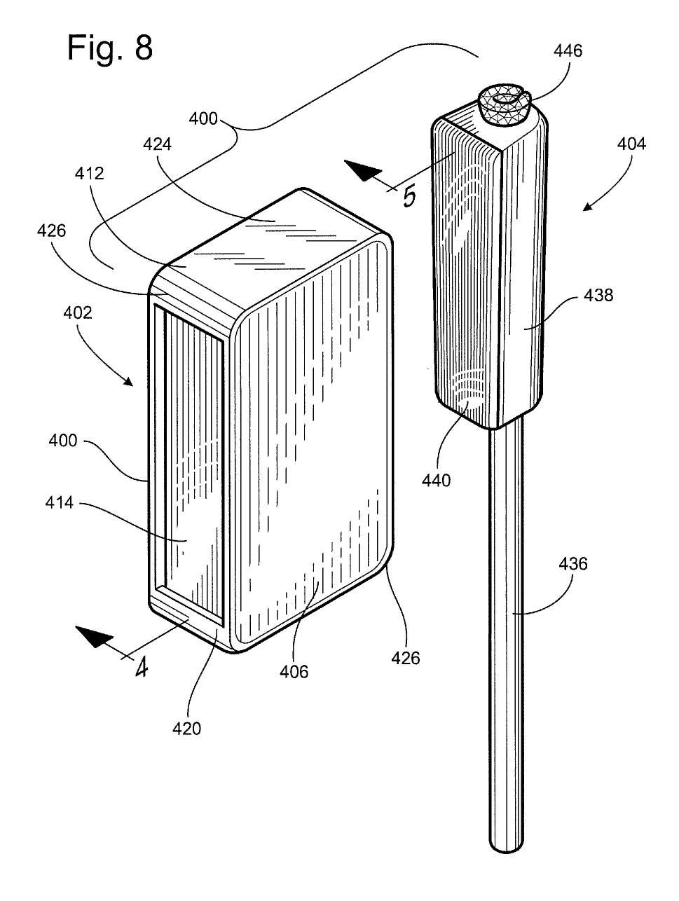

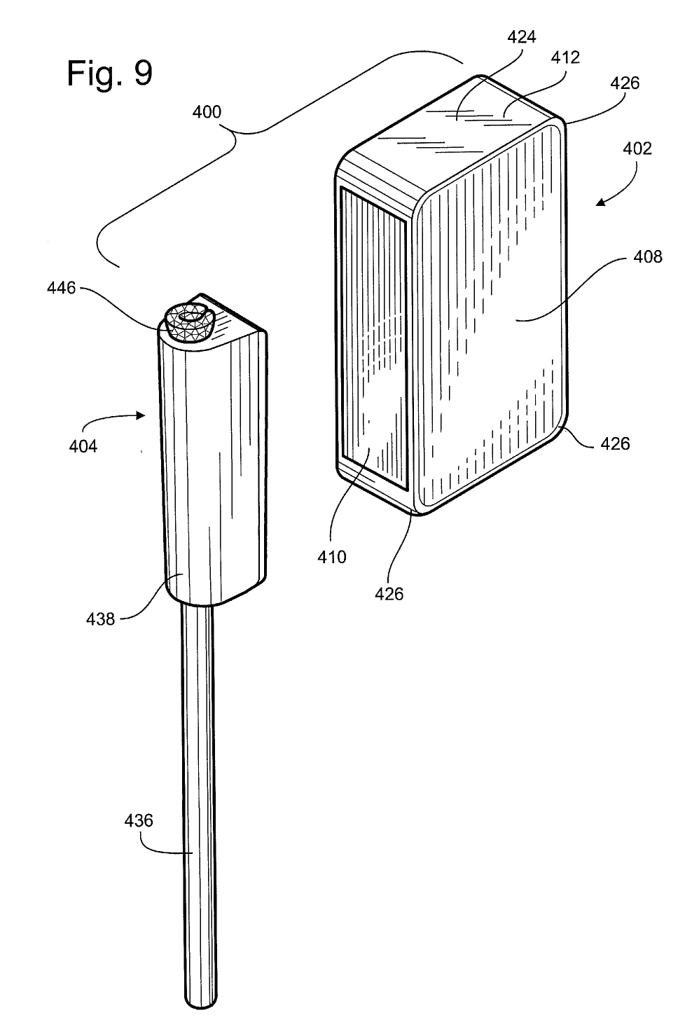

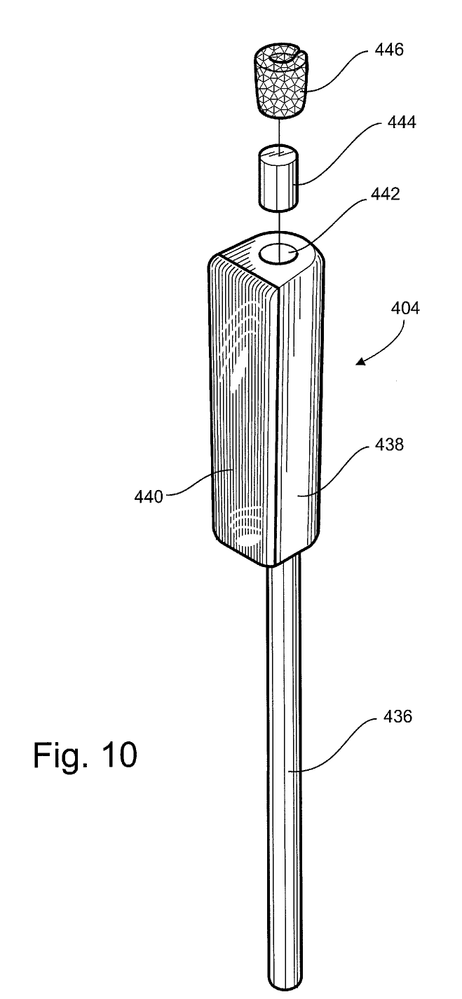

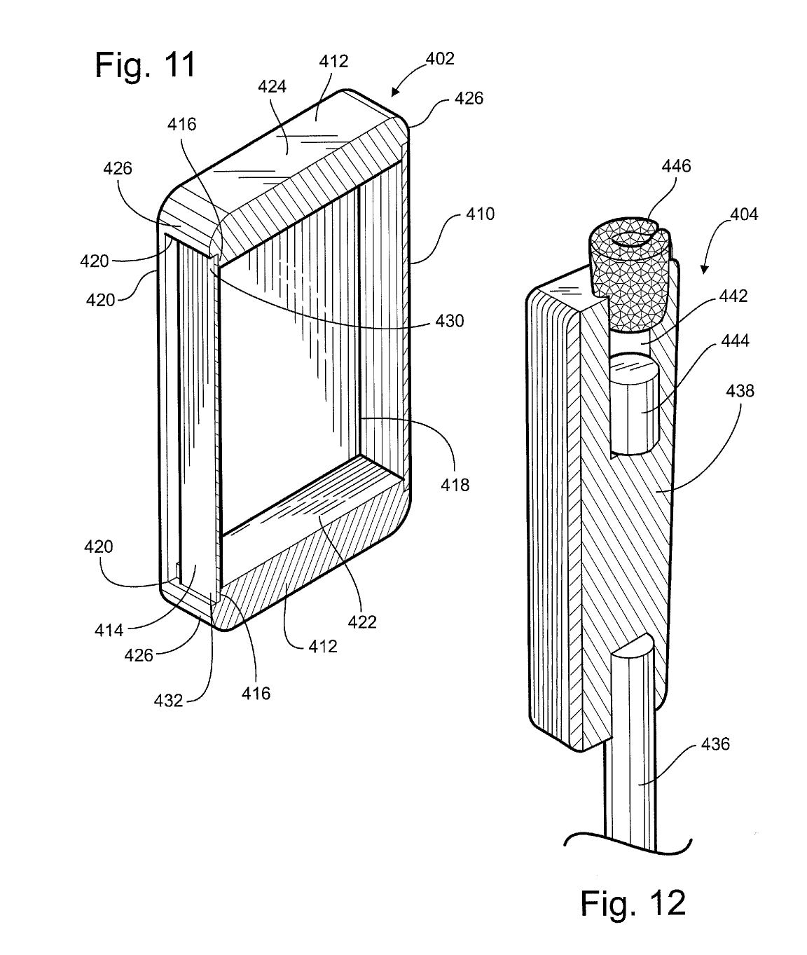

Referring now specifically to the drawings, an alternative exemplary embodiment of the call is illustrated in FIGS. 8-12 and is shown generally at reference numeral 400. The call generally consists of a box 402 and a striker 404. The box 402 includes a bottom side 406, a top side 408, a slate side 410, and an opposed ends 412 that collectively form a cavity. A flexible sounding board 414 is contained within the cavity. Specifically, the ends 412 contain a shelf 416 for retaining the entire flexible sounding board 414 within the cavity of the box 402.

The box 402 includes a slate side 410 that extends to an outer edge 418. The opposed ends 412 extend at an angle from the outer edge 418 to an upper edge 420. The ends 412 each have inner and outer end surfaces 422, 424. The ends 412 interconnect the bottom side 406 and top side 408 to define corners 426 and an interior cavity. The bottom side 406, the top side 408, and the ends 412 include an upper edge 420 that defines the uppermost surface of the cavity.

The shelf 416 on each end 412 is disposed on the end 412 within the cavity. The shelf 416 may be removable, or preferably, the shelf 416 is formed within the end 412 and positioned within the cavity of the box 402. A shelf 416 is positioned on the inner surface 422 of each of the ends 412 and below the upper edge 420 of the ends. Preferably, the shelf 416 on the inner surface 422 of each of the ends 412 is positioned deep enough within the cavity so that when the flexible sounding board 414 is engaged to the shelf 416, the flexible sounding board 414 is recessed below the upper edge 420 of the bottom side 406, top side 408, and opposed ends 412.

The flexible sounding board 414 contains a first end 430 and a second end 432. The first end 430 and the second end 432 of the flexible sounding board 414 are engaged to each shelf 416 disposed on the ends 412. The flexible sounding board 414 when engaged to each shelf 416 are suspended above the slate side 410 and recessed below the upper portions of the bottom side 406, top side 408, and two ends 412.

The flexible sounding board 414 is in a spaced-apart relationship with the bottom side 406 and top side 408 for allowing freer vibration. During use, the flexible sounding board 414 vibrates at a resonance that matches a turkey's call. When the user desires a slate strike call as disclosed above, the design of the box allows the user to project the call in a desired location. For example, as the user strikes the slate side 410 with the striker 404, the flexible sounding board 414 vibrates, thus creating the sound of a turkey call. The flexible sounding board 414 can be pointed in any direction while the user strikes the slate side 410 with the striker 404 to project the sound of a turkey call directionally.

It is important to note that the flexible sounding board 414 is not touched during operation of the call 400. The cavity of the box 402 acts much like a sound hole in a guitar, violin, or cello. Like the sound hole of the aforementioned instruments, the cavity of the box 402 is designed to allow the box 402 to project the sound of a turkey caused by the vibration of the flexible sounding board 414 more effectively. The majority of the turkey sound emanates from the area surrounding the flexible sounding board 414. The cavity of the box 402 allows the flexible sounding board to vibrate more freely, and by allowing some of the vibrations which have been set in motion inside the cavity to travel outside the cavity.

The corners 426 of the box 402 are preferably rounded or chamfered. Additionally, the upper edge 420 of the bottom side 406 and top side 408 are angled. In other words, the upper edge 420 of the bottom side 406 and top side 408 are angled downward towards the cavity. The degree of inclination is at such an angle as to cause the flexible sounding board 414 to resonate or vibrate when the striker 404 is moved across the upper edge 420, causing the flexible sounding board 414 to create a turkey call.

Striker 404 includes a striker peg 436 and in a preferred embodiment, the striker peg 436 extends from a striker block 438. Striker peg 436 is preferably rounded or chamfered. Striker peg 436 and striker block 438 are preferably formed of wood, in particular. However, any suitable material known to one of ordinary skill in the art may be utilized, including but not limited to wood, plastic, plastic composites and the like. A slate 440 is affixed to at least one side of striker block 438. As shown in FIG. 12, a closed end channel 442 is disposed within the striker block 438 and is adapted to receive and store chalk 444 therein. Closed end channel 442 is selectively sealed with an abrasive 446 such as sandpaper, steel wool, a plug, or an abrasive sold by 3M.

As used herein, the term “slate side” may be defined as a side that is composed of either wood or plastic and having a piece of slate disposed upon the outer surface.

Thus, while there have been shown, described and pointed out novel features of the present invention as applied to preferred embodiments thereof, it will be understood that various omissions and substitutions and changes in the form and detail are contemplated and may be made by those skilled in the art without departing from the spirit and scope of the invention. It is the intention therefore to be limited only as indicated by the scope of the claims appended hereto. It is also to be understood that the following claims are intended to cover all of the generic and specific features of the invention herein described and all statements of the scope of the invention, which as a matter of language, might be said to fall there between.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A turkey call for producing the sound of a turkey comprising:
a bottom side, a top side, a slate side and a two ends collectively forming a cavity therein;
a flexible sounding board having a first end and a second end positioned within the cavity, wherein the sounding board is capable of vibrating and producing the sound of a turkey;
the slate side having a slate disposed thereon; and
a striker, the striker having a strike peg and a block member, the strike peg extending from a surface of the block member.

2. The turkey call according to claim 1, further comprising a shelf positioned on each end for receiving the first end and the second end of the flexible sounding board.

3. The turkey call according to claim 1, wherein the flexible sounding board is recessed below the upper edge of the bottom side, top side, and the two ends.

4. The turkey call according to claim 1, wherein the flexible sounding board is in a spaced apart relationship with respect to the bottom side and the top side.

5. The turkey call according to claim 1, wherein the flexible sounding board is suspended above the slate side.

6. The turkey call according to claim 1, wherein the top side and the bottom side are curved.

7. The turkey call of claim 1, wherein said sounding board is recessed relative to a respective upper edge of said top surface and bottom surface, said block member is spaced from each of said top surface and said bottom surface and further comprising a slate extending along a side of said block and comprising a closed end channel formed within said block and a plug adapted to be received within said channel to close said channel.

8. The turkey call of claim 1, wherein said sounding board is recessed relative to a respective edge of said top surface and bottom surface, said sounding board is spaced from each of said top surface and said bottom surface and further comprising a slate extending along a side of said block member and comprising a closed end channel formed within said block member and a plug adapted to be received within said channel to close said channel.

9. A turkey call comprising:
a hollow housing having a top side, a bottom side, a slate side, and two opposed ends collectively forming a cavity therein, wherein the two opposed ends include an inner surface and an outer surface and a shelf is disposed on the inner surface of the two opposed ends;
a flexible sounding board having a first end and a second end positioned within the cavity, wherein the sounding board is capable of vibrating and producing the sound of a turkey;
the first end and the second end of the flexible sounding board are positioned on the shelf disposed on the inner surface of the two opposed ends;
the slate side having a slate disposed thereon; and
a striker, the striker having a strike peg and a block member, the strike peg extending from a surface of the block member.

10. The turkey call of claim 9, further comprising a closed end channel formed within said block member and a plug adapted to be received within said channel to close said channel to form a storage area therein.

11. The turkey call according to claim 9, wherein the flexible sounding board is recessed below the upper edge of the bottom side, top side, and the two ends.

12. The turkey call according to claim 9, wherein the flexible sounding board is in a spaced apart relationship with respect to the bottom side and the top side.

13. The turkey call according to claim 9, wherein the flexible sounding board is suspended above the slate side.

14. The turkey call according to claim 9, wherein the top side and the bottom side are curved.

15. The turkey call according to claim 9, wherein said sounding board is recessed relative to a respective upper edge of said top surface and bottom surface, said block member is spaced from each of said top surface and said bottom surface and further comprising a slate extending along a side of said block and comprising a closed end channel formed within said block and a plug adapted to be received within said channel to close said channel.

16. The turkey call according to claim 9, wherein said sounding board is recessed relative to a respective upper edge of said top surface and bottom surface, said sounding board is spaced from each of said top surface and said bottom surface and further comprising a slate extending along a side of said block member and comprising a closed end channel formed within said block member and a plug adapted to be received within said channel to close said channel.

17. A turkey call comprising:
a hollow housing having a top side, a bottom side, a slate side, and two opposed ends collectively forming a cavity therein, wherein the two opposed ends include an inner surface and an outer surface and a shelf is disposed on the inner surface of the two opposed ends;
a flexible sounding board having a first end and a second end positioned within the cavity, wherein the sounding board is capable of vibrating and producing the sound of a turkey;
the first end and the second end of the flexible sounding board are positioned on the shelf disposed on the inner surface of the two opposed ends;
the slate side having a slate disposed thereon;
a striker, the striker includes a striker peg and a striker block, the striker peg extending from a surface of the striker block; and
a closed end channel disposed within the striker block for storing chalk therein, wherein the closed end channel is selectively sealed with an abrasive.

18. The turkey call according to claim 17, further comprising a shelf positioned on each end for receiving the first end and the second end of the flexible sounding board.

19. The turkey call according to claim 17, wherein the flexible sounding board is recessed below the upper edge of the bottom side, top side, and the two ends.

20. The turkey call according to claim 17, wherein the flexible sounding board is in a spaced apart relationship with respect to the bottom side and the top side.
